(19) United States
(12) Patent Application Publication
(10) Pub. No.: US 2026/0004393 A1
(43) Pub. Date: Jan. 1, 2026

(54) PANORAMIC STITCHING METHOD, PANORAMIC STITCHING APPARATUS, ELECTRONIC DEVICE, AND STORAGE MEDIUM

(71) Applicant: Rockchip Electronics Co., Ltd., Fuzhou (CN)

(72) Inventors: Da XU, Fuzhou (CN); Yangming XIE, Fuzhou (CN)

(73) Assignee: Rockchip Electronics Co., Ltd., Fuzhou (CN)

(21) Appl. No.: 19/231,572

(22) Filed: Jun. 9, 2025

(30) Foreign Application Priority Data
Jun. 27, 2024 (CN) 202410850930X

(51) Int. Cl. G06T 3/4038; G06T 3/12; G06T 3/4007; G06T 7/80

(52) U.S. Cl. CPC G06T 3/4038; G06T 3/12; G06T 3/4007; G06T 7/80; G06T 2207/20221

(57) ABSTRACT

A panoramic stitching method, a panoramic stitching apparatus, an electronic device, and a storage medium are provided. The panoramic stitching method comprises acquiring captured images from cameras in a same scene; obtaining a remapping lookup table and a fusion lookup table generated based on a stitching model; and mapping and fusing the captured images based on the remapping lookup table and the fusion lookup table to obtain a panoramic stitched output image. The stitching model comprises a hemisphere and a cylinder, and an origin of a virtual camera coordinate system associated with the cameras is located at a center of a bottom surface of the hemisphere. The bottom surface is where the hemisphere is in contact with the cylinder. This method effectively reduces camera parallax and alignment errors, significantly enhancing the quality of panoramic stitching, which is particularly well-suited for open horizontal scenes, delivering exceptional visual stitching results.

### FIELD OF THE INVENTION

The present disclosure relates to the technical field of panoramic stitching, and in particular, to a panoramic stitching method, a panoramic stitching apparatus, an electronic device, and a storage medium.

### BACKGROUND OF THE INVENTION

Panoramic stitching technology merges images or videos captured by panoramic cameras within the same scene into panoramic visuals by stitching overlapping regions, enabling a wide field of view with high resolution while meeting functional requirements. Choosing the right stitching model is essential for achieving high-quality panoramic views. If the stitching distance defined in the model does not match the actual distance between the camera and the scene, it can result in alignment errors in the stitched images. These errors can appear as misalignments, seams, or ghosting, ultimately compromising the overall visual quality.

Currently, most approaches to panoramic stitching focus on the three-dimensional rotational relationship between cameras while overlooking their three-dimensional translation relationship, which leads to parallax issues. Some methods take the three-dimensional translation between cameras into account and incorporate stitching distance parameters to resolve parallax issues at a specific distance, but they fail to account for parallax across varying distance ranges. Other techniques use scene texture information and apply computer vision algorithms to align the images and address parallax. However, such methods are computationally intensive, perform poorly in low-texture environments, and struggle particularly in scenarios with abrupt depth changes. Additionally, while existing technologies enable image stitching in the spatial domain, they cannot handle video stitching in the temporal domain, limiting their effectiveness in dynamic scenarios. Also, correcting foreground parallax in overlapping regions can sometimes alter the background, resulting in a jarring visual experience for viewers.

### SUMMARY OF THE INVENTION

The present disclosure provides a panoramic stitching method, a panoramic stitching apparatus, an electronic device, and a storage medium, which minimize camera parallax and alignment errors during stitching, thereby significantly enhancing the quality of panoramic stitching.

A first embodiment of the present disclosure provides a panoramic stitching method. The panoramic stitching method comprises step S100 of acquiring captured images from cameras in a same scene; step S200 of obtaining a remapping lookup table and a fusion lookup table generated based on a stitching model, wherein the stitching model comprises a hemisphere and a cylinder, and an origin of a virtual camera coordinate system associated with the cameras is located at a center of a bottom surface of the hemisphere, wherein the bottom surface is where the hemisphere is in contact with the cylinder; and step S300 of successively mapping and fusing the captured images based on the remapping lookup table and the fusion lookup table to obtain a panoramic stitched output image.

In some examples of the present disclosure, a sphere center of the hemisphere is configured as the origin of the virtual camera coordinate system, and a radius of the hemisphere is configured as a farthest stitching distance. A center of an upper surface of the cylinder coincides with the origin of the virtual camera coordinate system, a center of a lower surface of the cylinder is configured as an origin of a world coordinate system, a radius of the cylinder corresponds to the farthest stitching distance, and a height of the cylinder is configured as an off-ground height of the cameras.

In some examples of the present disclosure, step S300 comprises: performing texture mapping on overlapping regions of the captured images based on the remapping lookup table to obtain first mapped images; performing texture mapping on non-overlapping regions of the captured images based on the remapping lookup table to obtain second mapped images; performing image fusion on the first mapped images based on the fusion lookup table to obtain fused images; and stitching the second mapped images and the fused images to obtain the panoramic stitched output image.

In some examples of the present disclosure, the remapping lookup table and the fusion lookup table are generated by: calibrating the cameras to determine internal parameters and external parameters of the cameras; configuring first stitching parameters and second stitching parameters, wherein the first stitching parameters are configured as imaging parameters of an output image, and the second stitching parameters are related to the stitching model; constructing the remapping lookup table and the fusion lookup table based on the internal parameters, the external parameters, the first stitching parameters, and the second stitching parameters; and saving the remapping lookup table and the fusion lookup table.

In some examples of the present disclosure, the first stitching parameters comprise one or more of the following: a width of the output image, a height of the output image, a horizontal field of view of the output image, a vertical field of view of the output image, a horizontal offset of the center point of the output image, a vertical offset of the center point of the output image, and a projection mode of the output image. The second stitching parameters comprise an off-ground height of the cameras and a farthest stitching distance.

In some examples of the present disclosure, the remapping lookup table is constructed by: traversing first coordinates (x, y) of the output image; back-projecting each pair of the first coordinates (x, y) onto a spherical surface with the origin O_{c} of the virtual camera coordinate system as a sphere center, and denoting a corresponding projection point as P_{c} and a corresponding ray as

$${O}_{c} {P}_{c}^{dir} ;$$

calculating a direction vector

$${P}_{c}^{dir}$$

of the ray based on the first stitching parameters; determining a mode length S of the direction vector

$${P}_{c}^{dir}$$

based on the second stitching parameters; calculating second coordinates [P_{cx} P_{cy} P_{cz}]^{T} of the projection point P_{c} in the virtual camera coordinate system using a formula given by:

$${P}_{c} = S * {P}_{c}^{dir} ;$$

calculating third coordinates [X_{c} Y_{c} Z_{c}]^{T} of the projection point P_{c} in a different physical camera coordinate system based on the external parameters and the second coordinates [P_{cx} P_{cy} P_{cz}]^{T}; and converting the third coordinates [X_{c} Y_{c} Z_{c}]^{T} into pixel coordinates (u, v) of corresponding input images based on the internal parameters.

In some examples of the present disclosure, the direction vector

$${P}_{c}^{dir}$$

of the ray is calculated using following formulas:

$$dx = \frac{2 * ( x - dst\_center \_x )}{dst\_width} * \frac{dst\_fov \_x}{360} ;$$

$$dy = \frac{2 * ( y - dst\_center \_y )}{dst\_height} * \frac{dst\_fov \_y}{180} ; and$$

$${P}_{c}^{dir} = {( {P}_{cx}^{dir} , {P}_{cy}^{dir} , {P}_{cz}^{dir} )}^{T} = [ \begin{matrix}cos ( π * dy / 2. ) * sin ( π * dx ) \\ cos ( π * dy / 2. ) * cos ( π * dx ) \\ - sin ( π * dy / 2. )\end{matrix} ] ;$$

where dst_center_x represents a horizontal offset of a center point of the output image, dst_center_y represents a vertical offset of the center point of the output image, dst_fov_x represents a horizontal field of view of the output image, dst_fov_y represents a vertical field of view of the output image, dst_width represents a width of the output image, and dst_height represents a height of the output image.

In some examples of the present disclosure, the mode length S of the direction vector

$${P}_{c}^{dir}$$

is determined using following formulas:

when

$${P}_{cz}^{dir} > 0 , S = R ;$$

when

$${P}_{cz}^{dir} <= 0 and \frac{- {P}_{cz}^{dir}}{h} > R , S = \frac{R}{\sqrt{{( {P}_{cx}^{dir} )}^{2} + {( {P}_{cy}^{dir} )}^{2}}} ,$$

when

$${P}_{cz}^{dir} <= 0 and \frac{- {P}_{cz}^{dir}}{h} > R , S = - \frac{h}{{P}_{cz}^{dir}} ;$$

where

$${P}_{cx}^{dir}$$

represents an x-direction coordinate point of the direction vector

$${P}_{c}^{dir} , {P}_{cy}^{dir}$$

represents a y-direction coordinate point of the direction vector

$${P}_{c}^{dir} , {P}_{cz}^{dir}$$

represents a z-direction coordinate point of the direction vector

$${P}_{c}^{dir} ,$$

R represents a farthest stitching distance, and h represents an off-ground height of virtual cameras.

In some examples of the present disclosure, the third coordinates [X_{c} Y_{c} Z_{c}]^{T}) of the projection point P_{c} in a different physical camera coordinate system is calculated using a formula given by:

$${P}_{0} = {T}_{0 c} * {P}_{c} ; {P}_{1} = {T}_{01}^{- 1} {T}_{0 c} * {P}_{c} ; and {P}_{2} = {T}_{02}^{- 1} {T}_{0 c} * {P}_{c}$$

where P_{c} [P_{cx} P_{cy} P_{cz}]^{T} represents the second coordinates of the projection point P_{c} in the virtual camera coordinate system, T_{0c} represents external parameter matrix, T₀₁ represents external parameters of Camera 1 relative to Camera 0, T₀₂ represents external parameters of Camera 2 relative to Camera 0, P₀ represents coordinates of the projection point P_{c} in coordinate system of Camera 0, P₁ represents coordinates of the projection point P_{c} in coordinate system of Camera 1, and P₂ represents coordinates of the projection point P_{c} in coordinate system of Camera 2.

In some examples of the present disclosure, the third coordinates [X_{c} Y_{c} Z_{c}]^{T} are converted into the pixel coordinates (u, v) of corresponding input images using following formulas:

$$[ \begin{matrix}{x}^{′} \\ {y}^{′}\end{matrix} ] = [ \begin{matrix}{X}_{c} / {Z}_{c} \\ {Y}_{c} / {Z}_{c}\end{matrix} ] ;$$

$${r}^{2} = {x}^{′2} + {y}^{′2} ;$$

$$[ \begin{matrix}{x}^{″} \\ {y}^{″}\end{matrix} ] = [ \begin{matrix}{x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}^{′} {y}^{′} + {p}_{2} ( {r}^{2} + 2 {x}^{′2} ) \\ {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′2} ) + 2 {p}_{2} {x}^{′} {y}^{′}\end{matrix} ] ; and$$

$$[ \begin{matrix}u \\ v\end{matrix} ] = [ \begin{matrix}{f}_{x} {x}^{″} + {c}_{x} \\ {f}_{y} {y}^{″} + {c}_{y}\end{matrix} ] ;$$

where k₁, k₂, k₃, k₄, k₅ and k₆ represent radial distortion coefficients, p₁ and p₂ represent tangential distortion coefficients, fₓ and f_{y} represent focal lengths of the cameras, and cₓ and c_{y} represent offsets of center points of the images.

In some examples of the present disclosure, step S300 comprises: dividing the captured images into overlapping regions and non-overlapping regions; performing texture mapping on the overlapping regions based on the remapping lookup table to obtain overlapping regions subjected to texture mapping; performing image fusion on the overlapping regions subjected to texture mapping based on the fusion lookup table to obtain overlapping regions subjected to image fusion; performing texture mapping on the non-overlapping regions based on the remapping lookup table to obtain non-overlapping regions subjected to texture mapping; and stitching the overlapping regions subjected to image fusion and the non-overlapping regions subjected to texture mapping to obtain the panoramic stitched output image.

In some examples of the present disclosure, performing texture mapping on the overlapping regions comprises: traversing coordinates (x, y) of the panoramic stitched output image; querying, based on the coordinates (x, y), coordinates (mapx(x,y), mapy(x,y)) of corresponding input images in the remapping lookup table; performing image content interpolation on the corresponding input images, and obtaining interpolation results at the coordinates (mapx(x,y), mapy(x,y)); and filling the interpolation results into the coordinates (x, y) of the panoramic stitched output image.

In some examples of the present disclosure, performing image fusion on the overlapping regions subjected to texture mapping comprises: performing image fusion on the overlapping regions subjected to texture mapping by one of an Alpha fusion algorithm, a multi-band fusion algorithm, and a Poisson fusion algorithm.

In some examples of the present disclosure, performing image fusion on the overlapping regions subjected to texture mapping by the Alpha fusion algorithm comprises: traversing coordinates (x, y) of the panoramic stitched output image; for each pair of the coordinates (x, y), querying a corresponding alpha value alpha(x, y) in the fusion lookup table; acquiring a pixel value Image c(x, y) of corresponding input images; calculating a fused pixel value based on the alpha value alpha(x, y) and the pixel value Image c(x,y); and filling the fused pixel value into the coordinates (x, y) of the panoramic stitched output image.

In some examples of the present disclosure, the fused pixel value is calculated using a formula given by:

$$Blend ( x , y ) = alpha ( x , y ) * Image 1 ( x , y ) + ( 1 - alpha ( x , y ) ) * Image 2 ( x , y ) ;$$

where alpha(x, y) represents the alpha value at the coordinates (x, y) in the fusion lookup table, Image1(x,y) represents the pixel value at the coordinates (x, y) in a first captured image, Image2(x,y) represents the pixel value at the coordinates (x, y) in a second captured image, and Blend(x,y) represents the fused pixel value.

In some examples of the present disclosure, calibrating the cameras to determine the internal parameters and the external parameters of the cameras comprises: collecting images of a first calibration board for internal parameter calibration as first calibration images; collecting images of a second calibration board for external parameter calibration as second calibration images; processing the first calibration images and the second calibration images based on a preset calibration algorithm to obtain internal parameters, external parameters, and a re-projection error of the cameras; and determining whether a calibration result of the cameras reaches a standard based on the re-projection error, if yes, saving the internal parameters and the external parameters; and if not, adjusting the first calibration board and the second calibration board, and/or replacing the preset calibration algorithm, and then calibrating the cameras until the calibration result of the cameras reaches the standard.

A second embodiment of the present disclosure provides a panoramic stitching apparatus. The panoramic stitching apparatus comprises an image acquisition module and an image stitching module. The image acquisition module is configured to acquire captured images from cameras in a same scene. The image stitching module is configured to obtain a remapping lookup table and a fusion lookup table generated based on a stitching model, successively map and fuse the captured images based on the remapping lookup table and the fusion lookup table to obtain a panoramic stitched output image. The stitching model comprises a hemisphere and a cylinder, and an origin of a virtual camera coordinate system associated with the cameras is located at a center of a bottom surface of the hemisphere. The bottom surface is where the hemisphere is in contact with the cylinder.

In some examples of the present disclosure, the panoramic stitching apparatus further comprises a lookup-table generation module, and the lookup-table generation module is configured to generate the remapping lookup table and the fusion lookup table based on the stitching model.

In some examples of the present disclosure, the image stitching module is configured to: perform texture mapping on overlapping regions of the captured images based on the remapping lookup table to obtain first mapped images; perform texture mapping on non-overlapping regions of the captured images based on the remapping lookup table to obtain second mapped images; perform image fusion on the first mapped images based on the fusion lookup table to obtain fused images; and stitch the second mapped images and the fused images to obtain the panoramic stitched output image.

A third embodiment of the present disclosure provides an electronic device. The electronic device comprises a memory and a processor. The memory is configured to store an executable program. The processor is configured to execute the program, so that the electronic device executes the panoramic stitching method as described in the examples of the first embodiment of the present disclosure.

The presently disclosed panoramic stitching method, panoramic stitching apparatus, electronic device, and storage medium effectively reduce camera parallax and alignment errors, significantly enhancing the quality of panoramic stitching, and are particularly well-suited for open horizontal scenes, delivering exceptional visual stitching results. Furthermore, the computational load is minimal, eliminating the need for real-time detection or updates to the remapping and fusion lookup tables, further improving the efficiency and practicality of panoramic stitching.

### BRIEF DESCRIPTION OF DRAWINGS

FIG. 1a is a three-dimensional schematic diagram of Stitching Model A in the prior art.

FIG. 1b shows input images provided by a double-fisheye camera in the prior art.

FIG. 1c shows texture mapping of the double-fisheye camera.

FIG. 2a is a schematic diagram showing image parallax of the double-fisheye camera.

FIG. 2b is a comparison diagram of stitching seams with different stitching distances in the prior art.

FIG. 3 is a three-dimensional schematic diagram of Stitching Model C in the prior art.

FIG. 4a is a two-dimensional schematic diagram of Stitching Model D according to an embodiment of the present disclosure.

FIG. 4b is a three-dimensional schematic diagram of Stitching Model D, viewing from one angle.

FIG. 4c is a three-dimensional schematic diagram of Stitching Model D, viewing from another angle.

FIG. 5a is a schematic diagram of a multi-view camera according to an embodiment of the present disclosure.

FIG. 5b is a schematic diagram of a multi-view camera according to another embodiment of the present disclosure.

FIG. 6 is a flowchart of a panoramic stitching method according to an embodiment of the present disclosure.

FIG. 7 is a flowchart of generating a remapping lookup table and a fusion lookup table according to an embodiment of the present disclosure.

FIG. 8 is a flowchart of camera calibration of a panoramic stitching method according to an embodiment of the present disclosure.

FIG. 9 is a schematic diagram of back projection of the panoramic stitching method according to an embodiment of the present disclosure.

FIG. 10 is a schematic diagram showing a conversion relationship between a unit sphere and Stitching Model D according to an embodiment of the present disclosure.

FIG. 11 is a comparison diagram of Stitching Model D before and after an external parameter matrix adjustment of the panoramic stitching method according to an embodiment of the present disclosure.

FIG. 12a shows output images generated using the panoramic stitching method according to an embodiment of the present disclosure.

FIG. 12b shows output images generated using the panoramic stitching method according to another embodiment of the present disclosure.

FIG. 13a is a flowchart of image stitching of the panoramic stitching method according to an embodiment of the present disclosure.

FIG. 13b is a schematic diagram showing the division of overlapping regions and non-overlapping regions of captured images according to an embodiment of the present disclosure.

FIG. 13c is a schematic diagram showing the combination of the overlapping regions and the non-overlapping regions according to an embodiment of the present disclosure.

FIG. 14 is a schematic diagram of texture mapping of the panoramic stitching method according to an embodiment of the present disclosure.

FIG. 15a shows a first input image to be stitched using the panoramic stitching method, as viewed from one angle.

FIG. 15b shows a second input image to be stitched using the panoramic stitching method, as viewed from another angle.

FIG. 15c shows a panoramic stitched output image obtained by stitching the first input image and the second input image using the panoramic stitching method.

FIG. 16 is a schematic block diagram of a panoramic stitching apparatus according to an embodiment of the present disclosure.

FIG. 17 is a schematic block diagram of an electronic device according to an embodiment of the present disclosure.

### DETAILED DESCRIPTION OF THE INVENTION

The embodiments of the present disclosure will be described below. Those skilled can easily understand disclosure advantages and effects of the present disclosure according to contents disclosed by the specification. The present disclosure can also be implemented or applied through other different specific embodiments. Various details in this specification can also be modified or changed based on different viewpoints and applications without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

In addition, the terms like “first” and “second” are used for indication purpose only and should not be construed as indicating or implying relative importance or implicitly specifying numbers of technical features indicated. Thus, features qualified with terms like “first” and “second” may explicitly or implicitly include at least one such feature. Moreover, the technical solutions of various embodiments can be combined with each other, provided that such combinations can be implemented by those skilled in the art. If the combination of technical solutions results in contradictions or proves to be unfeasible, such combinations shall be deemed nonexistent and shall not fall within the scope of the present disclosure.

The fundamental principle of panoramic stitching technology involves starting with a panoramic camera as the central point and constructing a virtual sphere. Next, the images captured by various camera lenses are projected onto the virtual sphere based on a predetermined stitching model. The overlapping regions of these images are then fused together, creating a complete three-dimensional (3D) spherical image. Finally, using different projection methods, the coordinates on the spherical image are transformed from 3D space into a two-dimensional (2D) plane, resulting in a planar image and completing the panorama generation. This process is similar to unfolding the surface of a 3D globe into a 2D world map. The overlapping regions can utilize algorithms such as pyramid-based multi-band fusion or alpha fusion.

The basic workflow of image stitching may comprise offline calibration, stitching parameter setting, texture mapping, and image fusion. Offline calibration comprises determining internal parameters and external parameters of the cameras, with the external parameters relating to rotation and translation. Stitching parameter setting comprises configuring parameters like stitching distance, projection method, output field of view, and global Euler angles. Texture mapping comprises mapping textures for each of the cameras based on the stitching parameters. Image fusion comprises applying a fusion method to merge the texture-mapped images from multiple cameras into a single stitched image.

If offline calibration is precise but the configured stitching distance does not match the actual distance between the scene and the camera, the stitched image may suffer from misalignment, such as noticeable displacements, seams, or ghosting. The root cause of these issues lies in a mismatch between the predetermined stitching model and the real-world conditions.

The following introduces several stitching models.

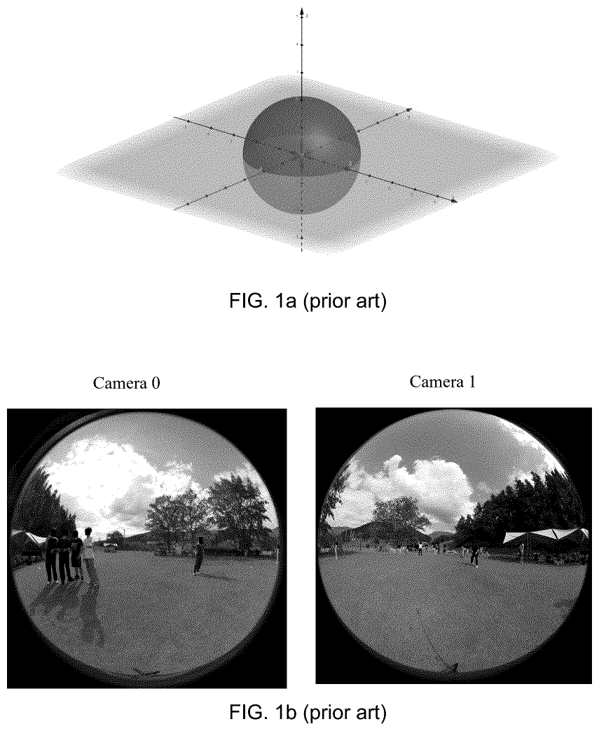

As shown in FIG. 1a, Stitching Model A is designed based on an idealized infinite sphere model. The sphere's radius is set to an extremely large value. Stitching Model A disregards the displacement between multiple cameras, assuming either that the optical centers of all cameras coincide or that the scene being captured is infinitely far away.

FIG. 1b shows the input images captured by a panoramic camera system made up of two back-to-back double-fisheye cameras. The panoramic camera system comprises Camera 0 and Camera 1, and is capable of capturing an ultra-wide field of view. Each of the double-fisheye cameras achieves a field of view of up to 200 degrees, providing comprehensive coverage of the surrounding environment.

FIG. 1c shows a schematic diagram of projecting the captured input images onto the virtual sphere.

Constructed based on Stitching Model A, Stitching Model B considers the displacement between multiple cameras and introduces the concept of stitching distance, i.e., configuring a distance that aligns the spherical model with the shooting scene. Properly setting the stitching distance eliminates image misalignment caused by parallax.

Parallax refers to the apparent positional change of an object when viewed from two different locations. Since it is nearly impossible to perfectly align the optical centers of multiple cameras during assembly, a certain distance will always exist between optical centers of the cameras, leading to parallax. The closer the object is to the cameras, the more pronounced the parallax becomes.

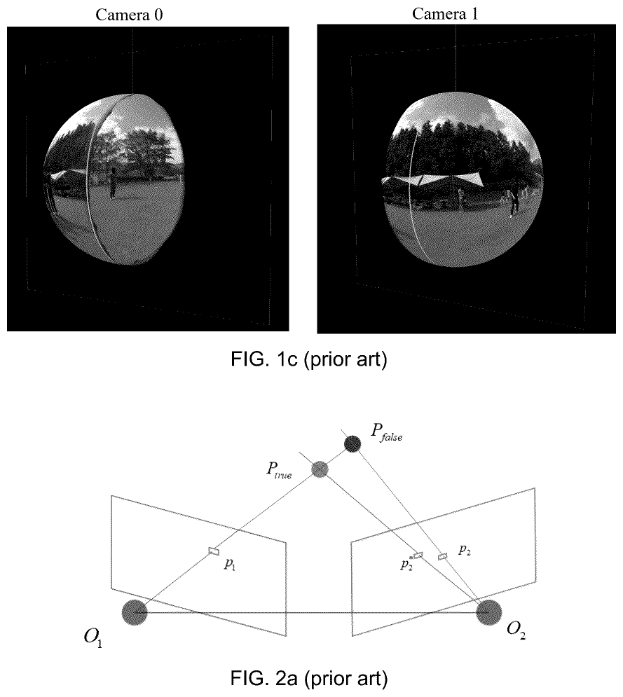

As shown in FIG. 2a, O1 and O2 represent the camera centers, while points Pₜᵣᵤₑ and P_{false} show 3D coordinates in the real world (using a correct stitching distance) and 3D coordinates in the virtual world (using an incorrect stitching distance) of the object, respectively. In the coordinate system of Camera O1, the lines connecting Pₜᵣᵤₑ to O1 and O2 correspond to intersection points P1 and P2* on the image planes, where the image content at Point P1 matches that at Point P2*. However, the line connecting P_{false} to O2 intersects the image plane at Point P2, resulting in pixel displacement and inconsistent content between points P1 and P2. The larger the difference between Pₜᵣᵤₑ and P_{false}, the more significant the misalignment in the stitched image, manifesting as ghosting or seams. It should be noted that the 3D coordinates of Pₜᵣᵤₑ and P_{false} are defined within the coordinate system of Camera O1, and both Pₜᵣᵤₑ and P_{false} lie on the same line as O1. From Camera O1's perspective, Pₜᵣᵤₑ and P_{false} coincide, differing only in their relative distances to O1. When projected into a 2D plane, distance information is lost, causing projections of Pₜᵣᵤₑ and P_{false} to coincide at Point P1.

For Stitching Model B, the selection of an appropriate stitching distance and the compatibility with the scene significantly impacts stitching quality. However, Stitching Model B supports only a single stitching distance, meaning the stitching distances for all points on the model (i.e., surface of the sphere) stay the same. In real-world scenarios, where object distances from the cameras vary, this limitation often results in large discrepancies between Pₜᵣᵤₑ and P_{false} in certain areas, causing visible seams.

FIG. 2b shows the effects of different stitching distances on seam visibility, with distances set to 5 m, 10 m, and 40 m. For each distance, the left image displays the overlap zone, i.e., a fused region, between two cameras across the entire panorama, while the right image offers a partial enlarged view of a scene with distinctive features. As the stitching distance increases, nearby objects, such as the “warning sign,” progressively develop visible seams (appearing transparent), while distant objects, like the “trees,” gradually lose their seams (appearing as ghosting).

By selecting optimal stitching distances, stitching results can be tailored for objects at different distances. A smaller optimal stitching distance yields better stitching results for closer objects, while a larger optimal stitching distance improves stitching for distant objects. Depending on the scene, the optimal distance can be set. Specifically, scenes with mostly distant objects utilize a larger stitching distance, while scenes with mostly near objects utilize a smaller stitching distance. However, Stitching Model B struggles in open areas such as outdoor plazas or indoor-outdoor courts, where object distances to the camera vary continuously.

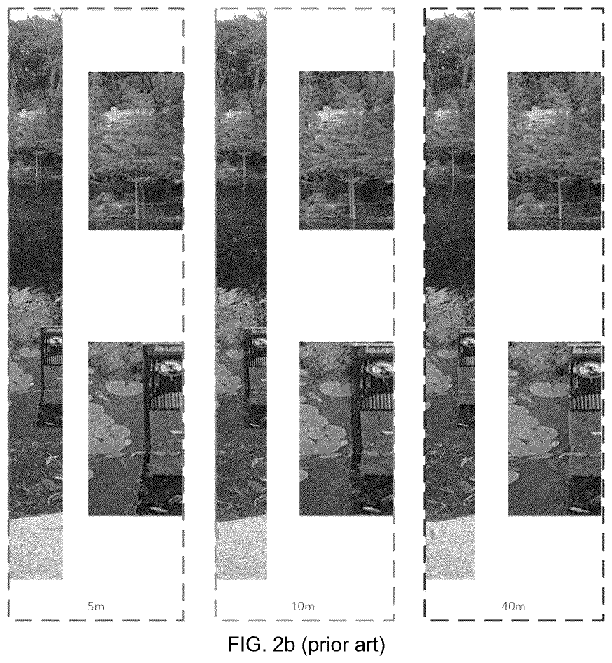

The present disclosure introduces new Stitching Models C and D, constructed based on Stitching Model B. FIG. 3 is a schematic diagram of Stitching Model C.

As shown in FIG. 3, Stitching Model C comprises a hemisphere, and a sphere center of the hemisphere is configured as an origin O_{c} of a virtual camera coordinate system, and a radius of the hemisphere is configured as a farthest stitching distance.

The present disclosure modifies the traditional spherical model having a single stitching distance into a composite model comprising a hemisphere and a horizontal plane (also referred to as the ground plane). The part above the horizontal plane remains a segment of a sphere, similar to Stitching Model B. However, Stitching Model C cannot be practically applied. Specifically, as the camera center O is situated on the horizontal plane, objects on the horizontal plane experience imaging degradation when captured by the camera. Exemplarily, when a person lies flat on the ground and observes the surroundings, even if objects have zero height (i.e., are flush with the ground), distant scenes may be obstructed by nearby objects, preventing the viewer from seeing the entire ground surface.

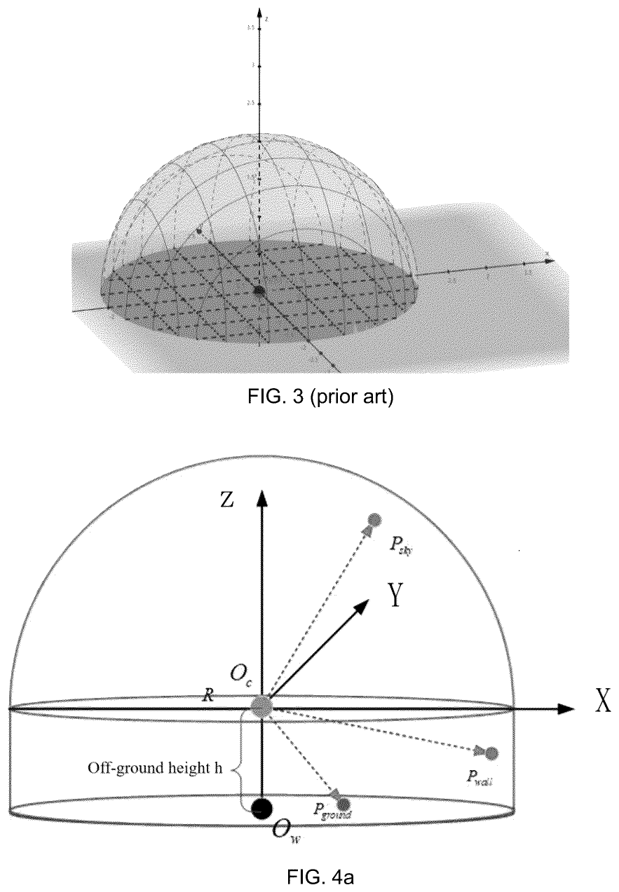

FIG. 4a is a 2D schematic diagram of Stitching Model D. FIGS. 4b and 4c provide 3D schematic diagrams of Stitching Model D from different viewpoints.

As shown in FIGS. 4a to 4c, Stitching Model D comprises a hemisphere and a cylinder. A sphere center of the hemisphere is configured as an origin O_{c} of a virtual camera coordinate system, and a radius of the hemisphere is configured as a farthest stitching distance R. A center of an upper surface of the cylinder coincides with the origin O_{c} of the virtual camera coordinate system, a center of a lower surface of the cylinder is configured as an origin O_{w} of a world coordinate system, a radius of the cylinder corresponds to the farthest stitching distance R, and a height of the cylinder is configured as an off-ground height h of the cameras. The origin O_{c} is located at the upper surface of the cylinder, while the origin O_{w} is positioned at the lower surface of the cylinder. The upper surface is where the hemisphere is in contact with or connected to the cylinder.

Unlike Stitching Models A, B, and C, the origin O_{c} of the virtual camera coordinate system in Stitching Model D is separate from the origin O_{w} of the world coordinate system. Stitching Model D is ideal for open areas such as outdoor plazas or indoor-outdoor courts, and delivers superior stitching performance.

Using the virtual camera coordinate system as a reference, direction vectors for light rays are generated from the origin O_{c}. In Stitching Model D, the direction vectors fall into three categories: upward-facing vectors, downward-facing near vectors, and downward-facing far vectors. The upward-facing vectors, representing the sky in a real-world scene, are referred to as sky vectors (P_{sky} or Point_sky). The downward-facing near vectors, representing the ground in the real-world scene, are referred to as ground vectors (P_{ground} or Point_ground). The downward-facing far vectors, representing distant walls, buildings, or the horizon, are referred to as wall vectors (P_{wall} or Point_wall). The off-ground height h represents the distance between the origin O_{c} and the origin O_{w} and must be measured based on the camera's actual installation. The farthest stitching distance R represents the distance between the camera and distant walls or buildings and must be configured by the user based on the specific application. If there are no obstructions in front of the cameras, the farthest stitching distance R can be set to a very large value to approximate infinity.

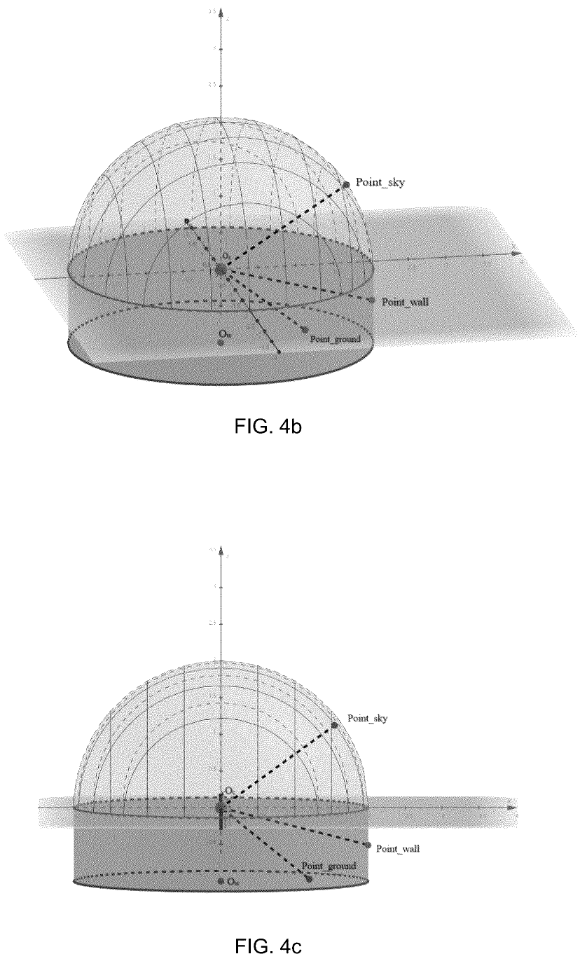

Stitching Model D supports scenarios where multi-view cameras are arranged horizontally and even allows for a slight downward tilt. As shown in FIG. 5a, the multi-view cameras are aligned horizontally with no downward tilt. In contrast, FIG. 5b depicts multi-view cameras arranged horizontally with a slight downward tilt.

The presently disclosed panoramic stitching method, panoramic stitching apparatus, electronic device, and storage medium effectively reduce camera parallax and alignment errors, significantly improving the visual quality of panoramic stitching. The present disclosure will be described in further detail below with reference to the accompanying drawings.

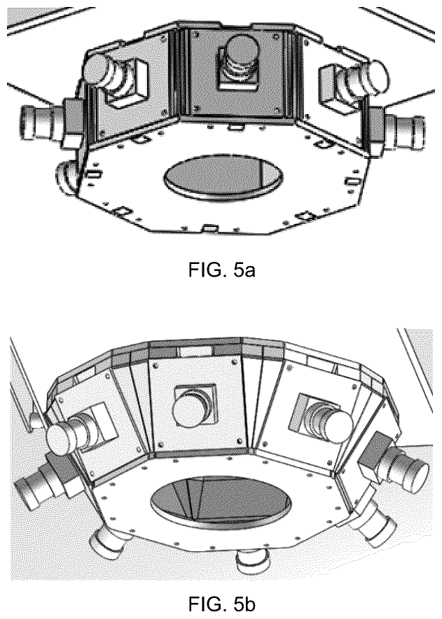

FIG. 6 shows the panoramic stitching method, which comprises steps S100 to S300.

Step S100 comprises acquiring captured images from cameras in a same scene.

In some embodiments, a panoramic camera system consisting of multiple fisheye cameras is employed to obtain the captured images. With sufficiently wide fields of view, these fisheye cameras collectively achieve 360-degree coverage. The fisheye cameras are precisely positioned in different directions, with overlapping regions between their fields of view. In addition, the panoramic camera system also supports precise synchronization control to ensure the fields of view captured at various time points accurately correspond.

The panoramic stitching method can also involve using the panoramic camera system to capture video streams, which would then require frame-by-frame processing.

Step S200 comprises obtaining a remapping lookup table (also referred to as remapping LUT) and a fusion lookup table (also referred to as fusion LUT) generated based on a stitching model. The stitching model comprises a hemisphere and a cylinder, and an origin of a virtual camera coordinate system associated with the cameras is located at a center of a bottom surface of the hemisphere. The bottom surface is where the hemisphere is in contact with or connected to the cylinder.

In some embodiments, a sphere center of the hemisphere is configured as the origin of the virtual camera coordinate system, and a radius of the hemisphere is configured as a farthest stitching distance. A center of an upper surface of the cylinder coincides with the origin of the virtual camera coordinate system, a center of a lower surface of the cylinder is configured as an origin of a world coordinate system, a radius of the cylinder corresponds to the farthest stitching distance, and a height of the cylinder is configured as an off-ground height of the cameras.

In some embodiments, the remapping lookup table and the fusion lookup table are first generated based on the stitching model and then retrieved.

In other embodiments, the remapping lookup table and the fusion lookup table are externally received.

Step S300 comprises mapping and fusing the captured images based on the remapping lookup table and the fusion lookup table to obtain a panoramic stitched output image.

In some embodiments, step S300 comprises: performing texture mapping on overlapping regions of the captured images based on the remapping lookup table to obtain first mapped images; performing texture mapping on non-overlapping regions of the captured images based on the remapping lookup table to obtain second mapped images. Additionally, step S300 further comprises performing image fusion on the first mapped images based on the fusion lookup table to obtain fused images; and stitching the second mapped images and the fused images to obtain the panoramic stitched output image.

The disclosed panoramic stitching method leverages the stitching model, the remapping lookup table, and the fusion lookup table to effectively minimize camera parallax and stitching alignment errors, significantly enhancing panoramic stitching quality. This method is particularly suited for open areas and delivers superior stitching performance. Furthermore, this method boasts low computational complexity, eliminating the need for real-time detection and updates to the remapping lookup table and the fusion lookup table, thereby improving stitching efficiency and usability.

In one embodiment of the present disclosure, the panoramic stitching method may further comprise step S400. Step S400 comprises generating the remapping lookup table and the fusion lookup table based on the stitching model.

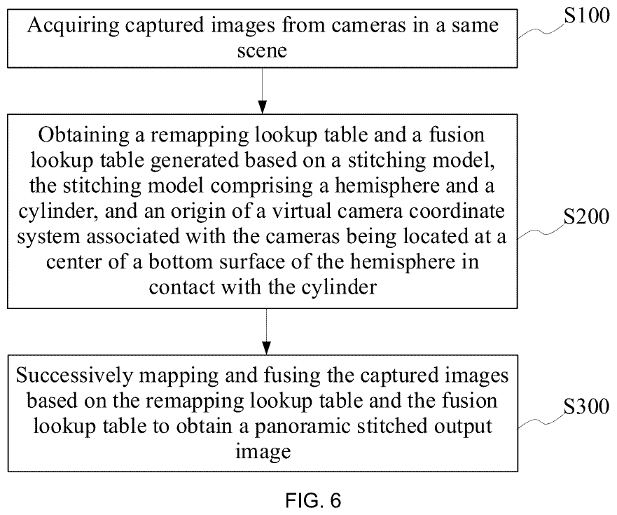

As shown in FIG. 7, step S400 may comprise: calibrating the cameras to determine internal parameters and external parameters of the cameras; configuring first stitching parameters and second stitching parameters, with the first stitching parameters configured as imaging parameters of an output image and the second stitching parameters related to the stitching model; constructing the remapping lookup table and the fusion lookup table based on the internal parameters, the external parameters, the first stitching parameters, and the second stitching parameters; and saving the remapping lookup table and the fusion lookup table.

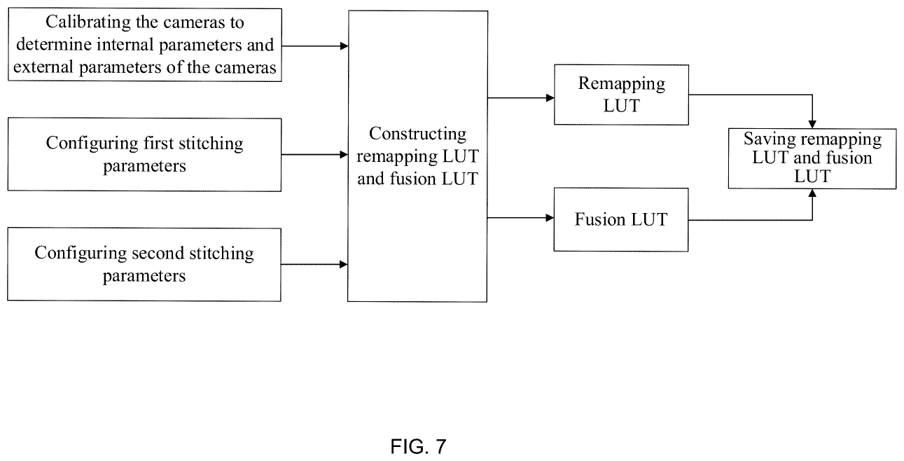

Specifically, as shown in FIG. 8, calibrating the cameras to determine the internal parameters and the external parameters of the cameras comprises: collecting images of a first calibration board for internal parameter calibration as first calibration images; collecting images of a second calibration board for external parameter calibration as second calibration images; processing the first calibration images and the second calibration images based on a preset calibration algorithm to obtain internal parameters, external parameters, and a re-projection error of the cameras; and determining whether a calibration result of the cameras reaches a standard based on the re-projection error, if yes, saving the internal parameters and the external parameters; and if not, adjusting the first calibration board and the second calibration board, and/or replacing the preset calibration algorithm; and then calibrating the cameras until the calibration result of the cameras reaches the standard.

In one embodiment of the present disclosure, the calibration boards can be one of: standard chessboard calibration boards, chessboard calibration boards with Quick Response (QR) code markers, and random noise calibration boards. For the chessboard calibration boards, feature points are defined as the corner points where the black and white squares intersect. For the random noise calibration boards, feature points are extracted using specialized algorithms such as Oriented FAST and Rotated BRIEF (ORB), Scale-Invariant Feature Transform (SIFT), or Speeded-Up Robust Features (SURF).

The calibration algorithm, including the Direct Linear Transformation (DLT) method or nonlinear least squares, can be employed to accurately determine the internal parameters and the external parameters of the cameras, thereby minimizing the re-projection error of paired feature points on the calibration boards. Generally, the calibration result is deemed precise when an average re-projection error is less than one pixel.

The internal parameters comprise an internal parameter matrix

$$K = [ \begin{matrix}fx & 0 & cx \\ 0 & fy & cy \\ 0 & 0 & 1\end{matrix} ]$$

and distortion coefficients, where fₓ and f_{y} represent focal lengths of the cameras, cₓ and c_{y} represent offsets of center points of the images, and the distortion coefficients depend on the camera model. For example, the pinhole imaging model has six radial distortion coefficients (k₁, k₂, k₃, k₄, k₅, and k₆) and two tangential distortion coefficients (p₁ and p₂). The fisheye model has four radial distortion coefficients (k₁, k₂, k₃, and k₄). The omnidirectional model has three radial distortion coefficients (k₁, k₂, and k₃), two tangential distortion coefficients (p₁ and p₂), and one mirror parameter (Cauchy ξ).

The external parameters comprise an external parameter matrix

$$T = [ \begin{matrix}r 00 & r 01 & r 02 & t 0 \\ r 10 & r 11 & r 12 & t 1 \\ r 20 & r 21 & r 22 & t 2 \\ 0 & 0 & 0 & 1\end{matrix} ] ,$$

where the 3×3 matrix in the upper-left corner represents the rotation matrix, and the 3×1 column vector in the upper-right corner represents the displacement vector.

In the present disclosure, the internal parameters and the external parameters are calibrated through offline processing. The calibrated internal parameters and external parameters are stored on a storage device in text or binary format.

It should be noted that each of the cameras requires its own calibration for internal parameters and external parameters. When the camera is securely and stably mounted, re-calibration is not required for subsequent use. However, when the camera is mounted unstably, subjected to collisions, or when the offline calibration results are unsatisfactory, online calibration can be conducted later as part of the online processing.

The present disclosure does not restrict the specific methods for online or offline calibration, nor does it restrict the camera models that can be used. The only requirement is to provide internal parameters that accurately describe the camera's imaging process and external parameters that define the relative positions between multiple cameras.

In one embodiment of the present disclosure, the first stitching parameters comprises one or more of the following: a width of the output image (dst_width, in pixels), a height of the output image (dst_height, in pixels), a horizontal field of view of the output image (dst_fov_x, in degrees), a vertical field of view of the output image (dst_fov_y, in degrees), a horizontal offset of the center point of the output image (dst_center_x, in pixels), a vertical offset of the center point of the output image (dst_center_y, in pixels), and a projection mode of the output image (project_mode).

It is worth mentioning that the first stitching parameters can be adjusted online. Once optimized for a specific application scenario, frequent changes or adjustments are generally unnecessary.

In one embodiment of the present disclosure, the second stitching parameters comprise the off-ground height h of the cameras and the farthest stitching distance R.

Using “project_mode” as an example of an equidistant rectangular projection, the remapping lookup table is constructed by: traversing first coordinates (x, y) of the output image; back-projecting each pair of the first coordinates (x, y) onto a spherical surface with the origin O_{c} of the virtual camera coordinate system as a sphere center, and denoting a corresponding projection point as P_{c} and a corresponding ray as

$${O}_{c} {P}_{c}^{dir} ;$$

calculating a direction vector

$${P}_{c}^{dir}$$

of the ray based on the first stitching parameters; determining a mode length S of the direction vector

$${P}_{c}^{dir}$$

based on the second stitching parameters; calculating second coordinates [P_{cx} P_{cy} P_{cz}]^{T} of the projection point P_{c} in the virtual camera coordinate system using a formula given by:

$${P}_{c} = S * {P}_{c}^{dir} ;$$

calculating third coordinates [X_{c} Y_{c} Z_{c}]^{T} of the projection point P_{c} in a different physical camera coordinate system based on the external parameters and the second coordinates [P_{cx} P_{cy} P_{cz}]^{T}; and converting the third coordinates [X_{c} Y_{c} Z_{c}]^{T} into pixel coordinates (u, v) of corresponding input images based on the internal parameters.

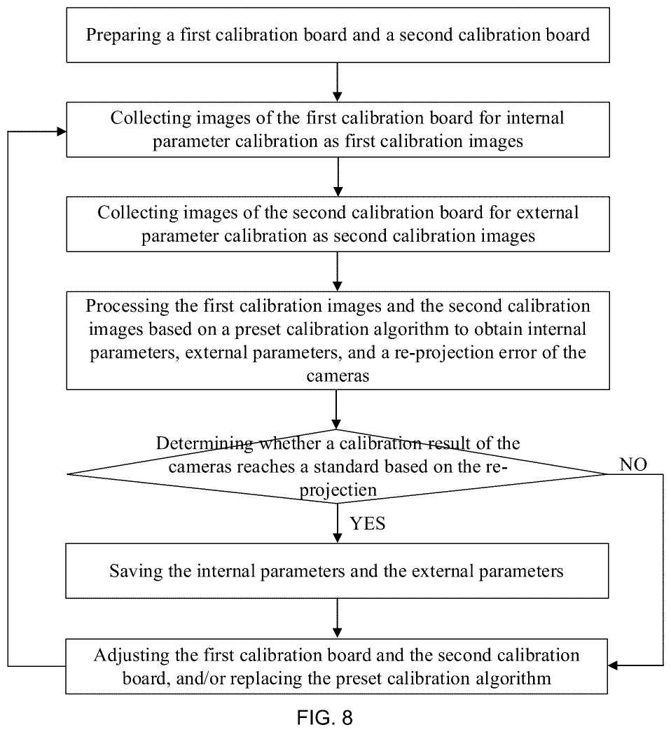

As shown in FIG. 9, the back projection process involves transforming the output image from its original planar coordinate system to a virtual sphere.

In one embodiment of the present disclosure, the direction vector

$${P}_{c}^{dir}$$

of the ray is calculated using following formulas:

$$dx = \frac{2 * ( x - dst\_center \_x )}{dst\_width} * \frac{dst\_fov \_x}{360} ;$$

$$dy = \frac{2 * ( y - dst\_center \_y )}{dst\_height} * \frac{dst\_fov \_y}{180} ; and$$

$${P}_{c}^{dir} = {( {P}_{cx}^{dir} , {P}_{cy}^{dir} , {P}_{cz}^{dir} )}^{T} = [ \begin{matrix}cos ( π os ( dy / 2. ) * sin ( 2. ) x ) \\ cos ( ( 2. ) / 2. ) cos ( π * dx ) \\ - sin ( \text{.0} ) ) / 2. )\end{matrix} ] ;$$

where dst_center_x represents a horizontal offset of a center point of the output image, dst_center_y represents a vertical offset of the center point of the output image, dst_fov_x represents a horizontal field of view of the output image, dst_fov_y represents a vertical field of view of the output image, dst_width represents a width of the output image, and dst_height represents a height of the output image.

Each of the sky vectors, the wall vectors, and the ground vectors corresponds to a different mode length S. In one embodiment of the present disclosure, the mode length S of the direction vector

$${P}_{c}^{dir}$$

is determined using following formulas:

when

$${P}_{cz}^{dir} > 0 , S = R ;$$

when

$${P}_{cz}^{dir} <= 0 and \frac{- {P}_{cz}^{dir}}{h} <= R , S = \frac{R}{\sqrt{{( {P}_{cx}^{dir} )}^{2} + {( {P}_{cy}^{dir} )}^{2}}} ;$$

when

$${P}_{cz}^{dir} <= 0 and \frac{- {P}_{cz}^{dir}}{h} <= R , S = - \frac{h}{{P}_{cz}^{dir}} ;$$

where

$${P}_{cx}^{dir}$$

represents an x-direction coordinate point of the direction vector

$${P}_{c}^{dir} , {P}_{cy}^{dir}$$

represents a y-direction coordinate point of the direction vector

$${P}_{c}^{dir} , {P}_{cz}^{dir}$$

represents a z-direction coordinate point of the direction vector

$${P}_{c}^{dir} ,$$

R represents a farthest stitching distance, and h represents an off-ground height of virtual cameras.

The second stitching parameters (including the off-ground height h of the cameras and the farthest stitching distance R) often require adjustments during the online processing stage to adapt to changes in the scene. When the off-ground height h and the farthest stitching distance R are configured incorrectly and don't match the actual scene conditions, noticeable stitching seams appear in the overlapping regions. These stitching seams typically manifest as objects splitting apart or becoming transparent. For example, when the actual off-ground height is three meters but the off-ground height h is configured as four meters, then according to the formula

$$S = - \frac{h}{{P}_{cz}^{dir}}$$

the objects on the ground will show prominent seams in the overlapping regions. Additionally, when the cameras are placed indoors and their overlapping regions align with a wall, with the cameras positioned twenty meters away from the wall and the farthest stitching distance R set to fifteen meters, then according to the formula

$$S = \frac{R}{\sqrt{{( {P}_{cx}^{dir} )}^{2} + {( {P}_{cy}^{dir} )}^{2}}} ,$$

the wall and objects on the wall will show noticeable seams in the overlapping regions as well.

As an example, the mode length S of the direction vector

$${P}_{c}^{dir}$$

represents the stitching distance in Stitching model B. The present disclosure introduces Stitching model D, which innovatively determine stitching distances that closely align with real-world conditions in open horizontal plane scenarios, thereby greatly enhancing stitching results.

In one embodiment of the present disclosure, after obtaining the direction vector

$${P}_{c}^{dir}$$

of the ray and the mode length S of the direction vector

$${P}_{c}^{dir} ,$$

the second coordinates [P_{cx} P_{cy} P_{cz}]^{T} of the projection point P_{c} in the virtual camera coordinate system can be calculated using the formula given by:

$${P}_{c} = S * {P}_{c}^{dir} ,$$

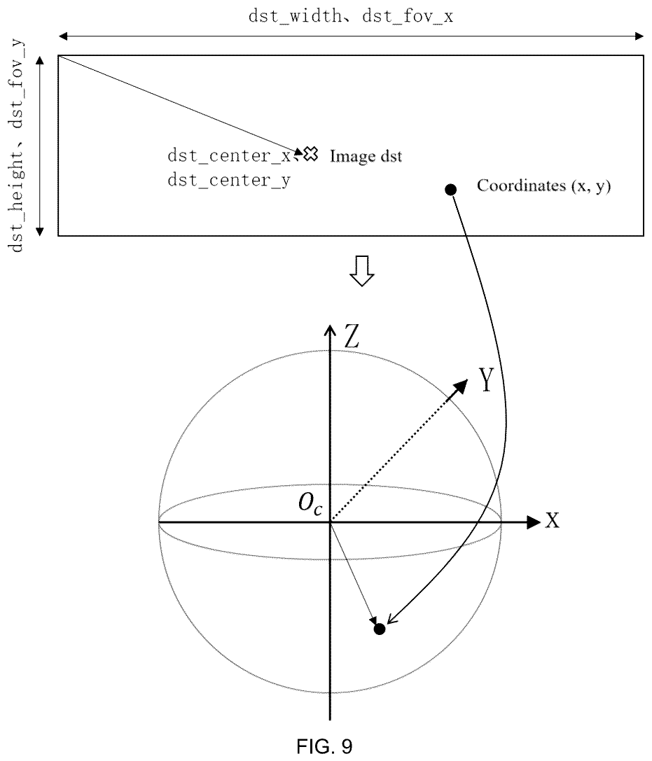

which is equivalent to transforming the output image from the virtual sphere to Stitching model D, as shown in FIG. 10.

The calculated second coordinates [P_{cx} P_{cy} P_{cz}]^{T} will be then converted into the third coordinates [X_{c} Y_{c} Z_{c}]^{T} in a real physical camera coordinate system. Taking as example three cameras arranged horizontally and tilted downward at a certain angle, an origin of the coordinate system of Camera 0 is labeled O₀, an origin of the coordinate system of Camera 1 is labeled O₁, and an origin of the coordinate system of Camera 2 is labeled O₂. Assume that the origin O₀ is aligned with the origin O_{c} and orientations of the coordinate systems also match, at which time, the external parameter matrix becomes a unit matrix, given by:

$${T}_{0 c} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

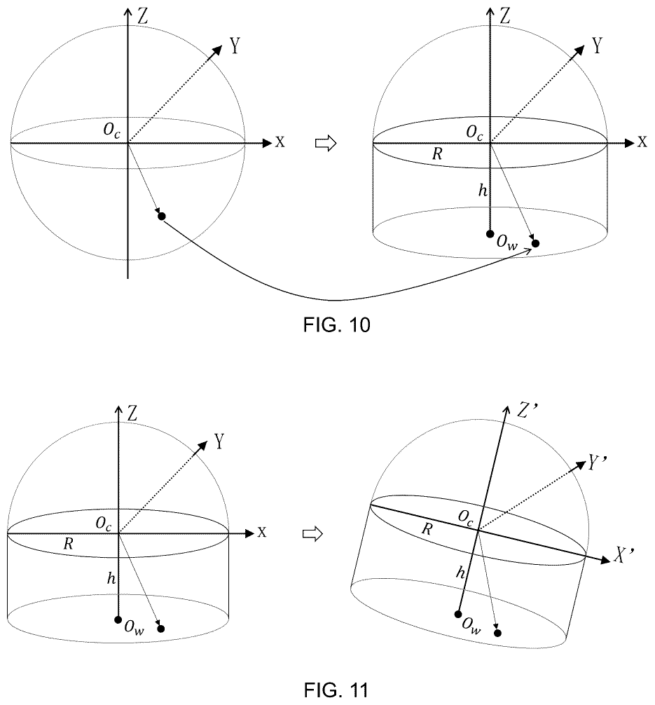

When the cameras are tilted downward at a specific angle, such as 30 degrees, the 3×3 matrix in the upper-left corner (i.e., the rotation matrix) requires adjustment. If no further modifications are necessary, it can still be assumed that the origin O₀ coincides with the origin O_{c}, meaning the 3×1 column vector in the upper-right corner (i.e., the displacement vector) remains zero, thereby leaving the external parameter matrix to consist only of the rotation matrix. By adjusting Toc, the final stitched image appears a horizontal form, as illustrated in FIG. 11. Since the final stitched image takes on a horizontal form, the virtual camera coordinate system is adjusted accordingly in the opposite direction.

In one embodiment of the present disclosure, the third coordinates [X_{c} Y_{c} Z_{c}]^{T} of the projection point P_{c} in a different physical camera coordinate system is calculated using a formula given by:

$${P}_{0} = {T}_{0 c} * {P}_{c} ; {P}_{1} = {T}_{01}^{- 1} {T}_{0 c} * {P}_{c} ; and {P}_{2} = {T}_{02}^{- 1} {T}_{0 c} * {P}_{c}$$

where [P_{cx} P_{cy} P_{cz}]^{T} represents the second coordinates of the projection point P_{c} in the virtual camera coordinate system, T_{0c} represents external parameter matrix, T₀₁ represents external parameters of Camera 1 relative to Camera 0, T₀₂ represents external parameters of Camera 2 relative to Camera 0, P₀ represents coordinates of the projection point P_{c} in coordinate system of Camera 0, P₁ represents coordinates of the projection point P_{c} in coordinate system of Camera 1, and P₂ represents coordinates of the projection point P_{c} in coordinate system of Camera 2.

It should be noted that T₀₁ and T₀₂ can be obtained through offline calibration.

Take the pinhole imaging model as an example, the third coordinates [X_{c} Y_{c} Z_{c}]^{T} are converted into the pixel coordinates (u, v) of corresponding input images using following formulas:

$$[ \begin{matrix}{x}^{′} \\ {y}^{′}\end{matrix} ] = [ \begin{matrix}{X}_{c} / {Z}_{c} \\ {Y}_{c} / {Z}_{c}\end{matrix} ] ;$$

$${r}^{2} = {x}^{′2} + {y}^{′2} ;$$

$$[ \begin{matrix}{x}^{″} \\ {y}^{″}\end{matrix} ] = [ \begin{matrix}{x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}^{′} {y}^{′} + {p}_{2} ( {r}^{2} + 2 {x}^{′2} ) \\ {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′2} ) + 2 {p}_{2} {x}^{′} {y}^{′}\end{matrix} ] ; and$$

$$[ \begin{matrix}u \\ v\end{matrix} ] = [ \begin{matrix}{f}_{x} {x}^{″} + {c}_{x} \\ {f}_{y} {y}^{″} + {c}_{y}\end{matrix} ] ;$$

where k₁, k₂, k₃, k₄, k₅ and k₆ represent radial distortion coefficients, p₁ and p₂ represent tangential distortion coefficients, fₓ and f_{y} represent focal lengths of the cameras, and cₓ and c_{y} represent offsets of center points of the images.

Thus, the remapping LUT is completely built. By traversing the coordinates (x, y) of the output image, mappings to the pixel coordinates (u, v) for each physical camera can be generated.

In one embodiment of the present disclosure, the fusion LUT is obtained by: creating an empty fusion LUT, traversing all pairs of coordinates within the fusion LUT; and setting fusion weight values at the coordinates based on the stitching model to obtain the fusion LUT.

It should be noted that the fusion weight values may be the same or different.

As an example, the remapping LUT is obtained based on Stitching Model D, which directly impacts whether the panoramic stitched output image has visible stitching defects or whether the image content is misaligned.

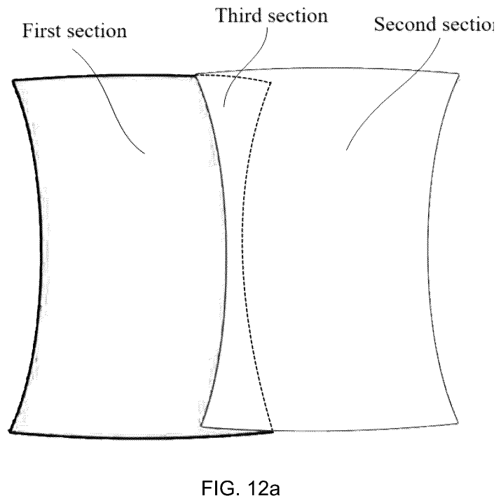

The results of Camera 0 and Camera 1 are traversed and rendered onto the output image, as shown in FIG. 12a. The first section represents the effective content from Camera 0, the second section shows the effective content from Camera 1, and the third section represents the overlapping effective content between Camera 0 and Camera 1. During the mapping process, when the pixel coordinates (u, v) exceed the resolution range of corresponding input images, the corresponding region is deemed invalid and represented in the fourth section.

In the mapping process, the edges of the images from Camera 0 or Camera 1 take on a curved shape. Since processing rectangular blocks of data is more efficient than processing curved-edge blocks of data, rectangular blocks are used to divide the images into non-overlapping regions and overlapping regions between cameras. This process also eliminates invalid black regions, as shown in FIG. 12b. Block 1 corresponds to Camera 0's non-overlapping region, containing the remapping LUT for that region. Block 2 corresponds to Camera 1's non-overlapping region, containing the remapping LUT for that region. Block 3 corresponds to the overlapping regions of Camera 0 and Camera 1, containing the remapping LUT for the overlapping regions. Once the remapping LUT for the overlapping regions is obtained, the fusion LUT for Alpha fusion or Multiband fusion can be constructed since the overlapping region's boundaries are already defined.

In one embodiment of the present disclosure, the remapping LUT and the fusion LUT are built through online processing. These LUTs only need to be executed once during device startup to obtain the necessary data. When the camera stitching setup or installation environment remains unchanged, the remapping LUT and the fusion LUT can be saved to storage for reuse during subsequent device startups or program launches. This “one-time execution” approach distinguishes this method from dynamic stitching, seam creation, or alignment techniques that require recalculating LUTs for every frame, significantly saving computational resources.

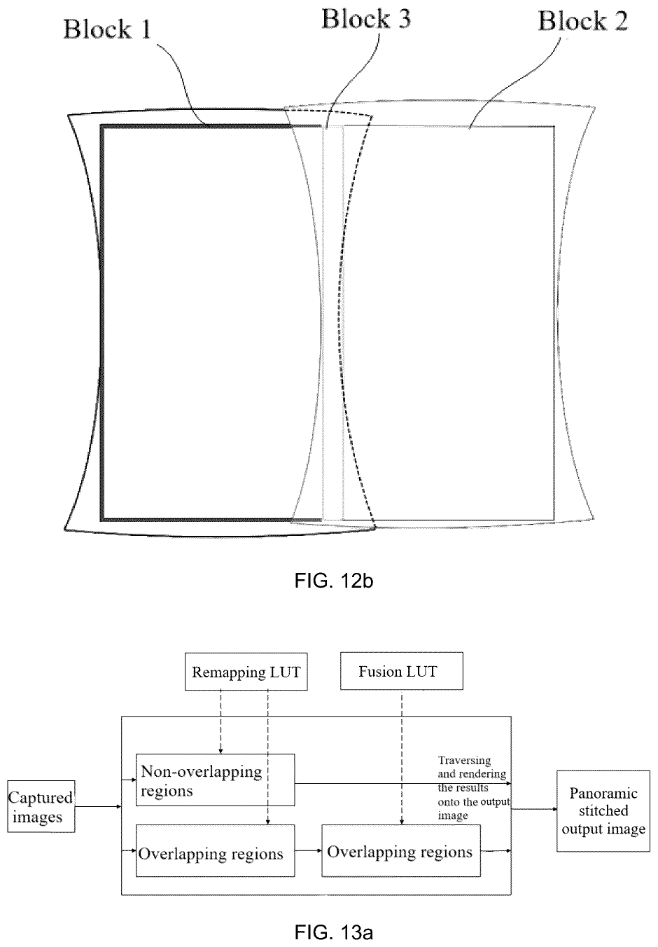

In one embodiment of the present disclosure, as shown in FIG. 13a, step S300 comprises: performing texture mapping on overlapping regions of the captured images based on the remapping lookup table to obtain first mapped images; performing texture mapping on non-overlapping regions of the captured images based on the remapping lookup table to obtain second mapped images; performing image fusion on the first mapped images based on the fusion lookup table to obtain fused images; and stitching the second mapped images and the fused images to obtain the panoramic stitched output image.

In another embodiment of the present disclosure, step S300 comprises steps S301 to S304.

Step S301 comprises dividing the captured images into overlapping regions and non-overlapping regions.

Step S302 comprises performing texture mapping on the overlapping regions based on the remapping lookup table to obtain overlapping regions subjected to texture mapping; and performing image fusion on the overlapping regions subjected to texture mapping based on the fusion lookup table to obtain overlapping regions subjected to image fusion.

Step S303 comprises performing texture mapping on the non-overlapping regions based on the remapping lookup table to obtain non-overlapping regions subjected to texture mapping.

Step S304 comprises stitching the overlapping regions subjected to image fusion and the non-overlapping regions subjected to texture mapping to obtain the panoramic stitched output image.

FIG. 13b shows the overlapping regions and non-overlapping regions of the captured images from Camera 0, Camera 1, and Camera 2. FIG. 13c is a schematic diagram showing the combination of the overlapping regions and the non-overlapping regions.

In one embodiment of the present disclosure, performing texture mapping on the overlapping regions comprises: traversing coordinates (x, y) of the panoramic stitched output image; for each pair of the coordinates (x, y), querying, based on the coordinates (x, y), coordinates (mapx(x,y), mapy(x,y)) of corresponding input images in the remapping lookup table; performing image content interpolation on the corresponding one of the captured images, and obtaining interpolation results at the coordinates (mapx(x,y), mapy(x,y)); and filling the interpolation results into the coordinates (x, y) of the panoramic stitched output image.

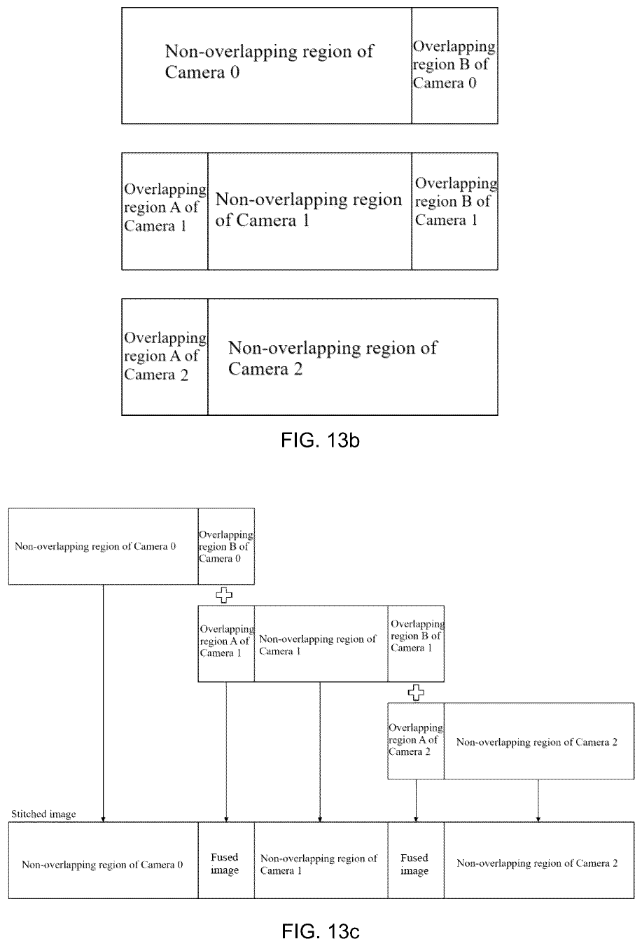

FIG. 14 is a schematic diagram of texture mapping of the panoramic stitching method according to an embodiment of the present disclosure.

In one embodiment of the present disclosure, the texture mapping is performed to correct distortions of the captured images. The image's back projection transformation and the alignment with the image content from adjacent cameras rely on the remapping LUT for accurate texture mapping coordinates. Texture mapping is an opposite mapping process and follows the formula: dst(x,y)=src(mapx(x, y),mapy(x, y)), where mapx and mapy represent the remapping LUT, src represents the captured image, and dst represents the output image.

Specifically, by traversing the coordinates (x, y) of the output image dst, which are integers, and querying the remapping LUT based on the coordinates (x, y), the coordinates (mapx(x,y), mapy(x,y)) corresponding to the captured image src are obtained. The coordinates (mapx(x,y), mapy(x,y)) are most likely fractional values. Therefore, the image content interpolation is performed on the captured image src by linear interpolation, cubic interpolation, or Lanczos interpolation, then the interpolation results are filled back to the coordinates (x, y) to obtain the pixel coordinates (u, v) of the captured image src corresponding to the coordinates (x, y).

It is worth noting that the texture mapping for non-overlapping regions follows the same procedure as that for overlapping regions.

The texture mapping can be executed using Central Processing Units (CPUs), Graphics Processing Units (GPUs), Digital Signal Processors (DSPs), or other hardware with texture mapping capabilities.

In one embodiment of the present disclosure, performing image fusion on the overlapping regions subjected to texture mapping comprises: performing image fusion on the overlapping regions subjected to texture mapping by one of an Alpha fusion algorithm, a multi-band fusion algorithm, and a Poisson fusion algorithm.

Alpha fusion algorithm is straightforward and resource-efficient but may result in transparency issues in the fused images. Multi-band fusion algorithm is more complex and resource-intensive, offering smoother transitions between low-frequency and high-frequency information for better visual quality. Poisson fusion algorithm is the most intricate but delivers the best fusion results overall. The fusion algorithm can be determined based on specific application requirements.

In one embodiment of the present disclosure, performing image fusion on the overlapping regions subjected to texture mapping by the Alpha fusion algorithm comprises: traversing coordinates (x, y) of the panoramic stitched output image; for each pair of the coordinates (x, y), querying a corresponding alpha value alpha(x, y) in the fusion lookup table; acquiring a pixel value Image c(x, y) of corresponding input images; calculating a fused pixel value based on the alpha value alpha(x, y) and the pixel value Image c(x,y); and filling the fused pixel value into the coordinates (x, y) of the panoramic stitched output image.

Specifically, the fused pixel value is calculated using a formula given by:

$$Blend ( x , y ) = alpha ( x , y ) * Image 1 ( x , y ) + ( 1 - alpha ( x , y ) ) * Image 2 ( x , y ) ;$$

where alpha(x,y) represents the alpha value at the coordinates (x, y) in the fusion lookup table, Image1(x,y) represents the pixel value at the coordinates (x, y) in a first captured image, Image2(x,y) represents the pixel value at the coordinates (x, y) in a second captured image, and Blend(x,y) represents the fused pixel value.

As an example, the image stitching process described in steps S301 to S304 is also performed through online processing.

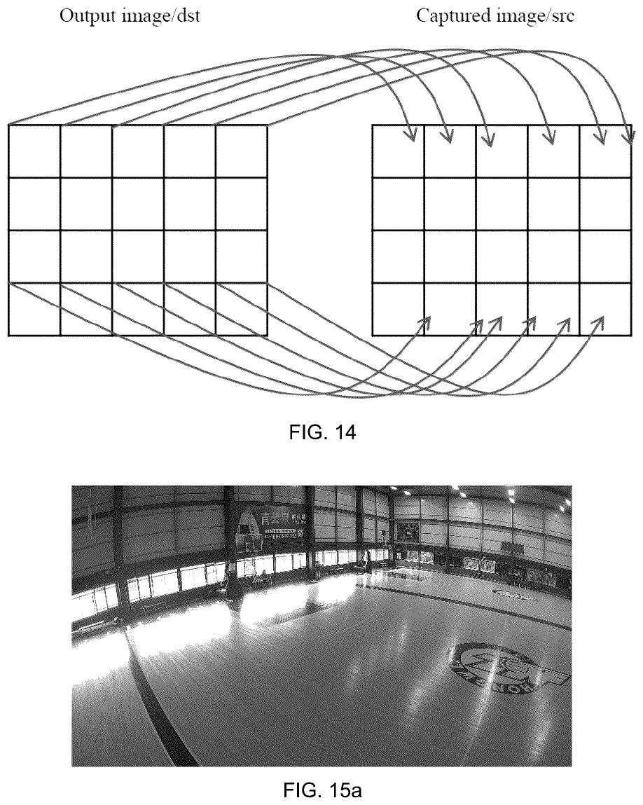

The presently disclosed panoramic stitching method is tested in an indoor basketball court environment. Two sets of images were prepared for comprehensive assessment. FIGS. 15a and 15b show input images (i.e., captured images) from different angles, while FIG. 15c presents the panoramic stitched output image obtained by stitching the input images using the panoramic stitching method.

By comparing the input images with the panoramic stitched output image, it is clear that the panoramic stitching method of the present disclosure reveals excellent panoramic stitching performance. In particular, the panoramic stitched output image demonstrates a seamless basketball court floor with no visible cracks or ghosting effects across near and far distances, indicating that the stitching process effectively merges multiple input images while preserving scene continuity and ensuring visual consistency.

It should be noted that the scope of the panoramic stitching method described in the embodiments of the present disclosure is not limited to the sequence of steps listed herein. Any scheme realized by adding or subtracting steps or replacing steps of the traditional techniques according to the principle of the present disclosure is included in the scope of the present disclosure.

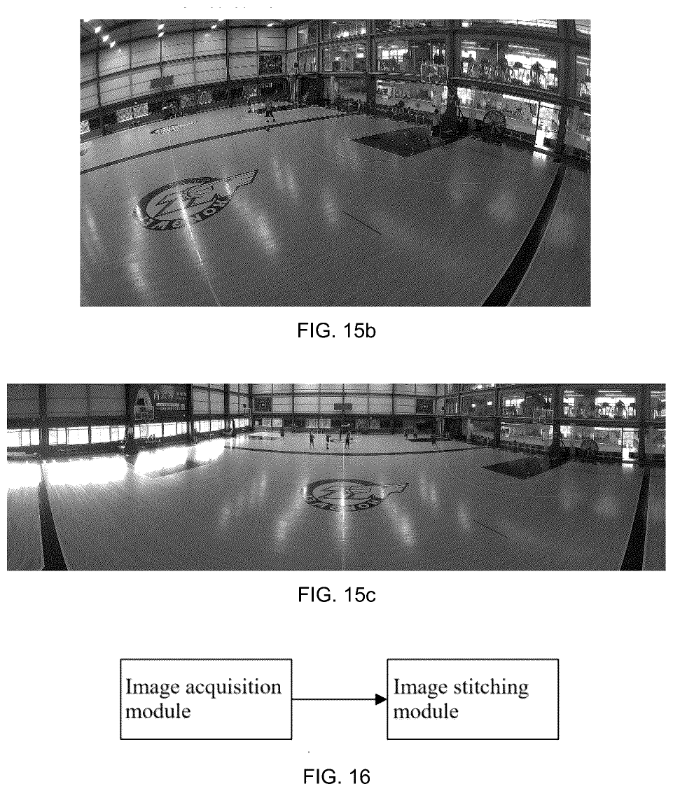

FIG. 16 shows a schematic block diagram of a panoramic stitching apparatus according to an embodiment of the present disclosure. The panoramic stitching apparatus comprises an image acquisition module and an image stitching module.

The image acquisition module is configured to acquire captured images from cameras in a same scene.

The image stitching module is configured to obtain a remapping lookup table and a fusion lookup table generated based on a stitching model, map. The stitching model comprises a hemisphere and a cylinder, and an origin of a virtual camera coordinate system associated with the cameras is located at a center of a bottom surface of the hemisphere. The bottom surface is where the hemisphere is connected to or in contact with the cylinder. The image stitching module is further configured to map and fuse the captured images based on the remapping lookup table and the fusion lookup table to obtain a panoramic stitched output image.

In one embodiment of the present disclosure, the panoramic stitching apparatus further comprises a lookup-table generation module. The lookup-table generation module is configured to generate the remapping lookup table and the fusion lookup table based on the stitching model.

In one embodiment of the present disclosure, the lookup-table generation module can be integrated into a chip. That is, the panoramic stitching apparatus can be integrated into a single system-on-chip (SoC), and the SoC can be further incorporated into an electronic device. In other embodiments of the present disclosure, the image acquisition module and the image stitching module can be integrated into a first chip, while the panoramic stitching apparatus can be integrated into a second chip. Both the first chip and the second chip are housed within a single electronic device, enabling the electronic device to independently execute the panoramic stitching method outlined in the present disclosure.

In addition, the lookup-table generation module can operate as a standalone module hosted in the cloud. This approach enables users to leverage the extensive computational power of cloud computing to generate the remapping lookup table and the fusion lookup table for image stitching. The image stitching module performs stitching operations by downloading the precomputed lookup tables from the cloud, which reduces the computational burden on local devices, making it possible for devices with limited processing power to achieve high-quality image stitching.

It should be noted that the image acquisition module, the image stitching module, and the lookup-table generation module can be configured to carry out the corresponding steps or actions of the panoramic stitching method as described above or match the method step-by-step.

The panoramic stitching apparatus described in the present disclosure is capable of implementing the panoramic stitching method discussed herein, but the apparatus for implementing the panoramic stitching method described in the present disclosure includes, but is not limited to, the apparatus as described in the present disclosure. Any structural adjustment or replacement of the prior art made according to the principles of the present disclosure is included in the scope of the present disclosure.

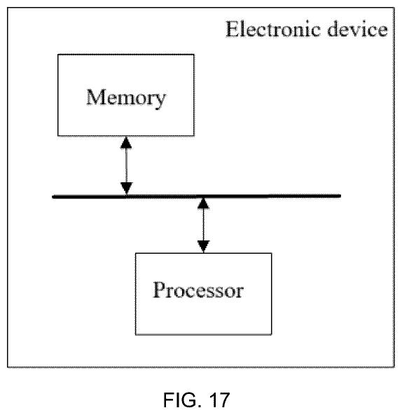

As shown in FIG. 17, the present disclosure provides an electronic device comprising a processor and a memory. The memory is configured to store a program to be executed by the processor. The processor is configured to execute the program, so that the electronic device executes the panoramic stitching method as described in the embodiments of the present disclosure.

In the several embodiments proposed in the present disclosure, the disclosed systems, devices, or methods can be implemented in other ways. For example, the embodiments of devices described above are only illustrative, and the division of modules or units is only a logical functional division. In actual implementation, there may be other division methods, such as multiple modules or units can be combined or integrated into another system, or some features can be ignored or not executed. Here, the coupling or direct coupling or communication connection between each other can be indirect coupling or communication connection through some interfaces, devices, modules, or units, and can be electrical connection, mechanical connection, or other connections.

The modules or units shown as separate components can be physically separated or not. The components shown as modules or units can be physical modules or not. That is, they can be located in one place, or they can also be distributed to multiple network units. Some or all of the modules or units can be selected as needed to achieve the purpose of the embodiment. For example, in one embodiment of the present disclosure, each functional module or unit can be integrated into one processing module. Each functional module or unit can exist physically separately, or two or more modules or units can be integrated into one module or unit.

The ordinary technical personnel in this field should further realize that the units and algorithm steps of each example described in combination with the embodiments disclosed here can be implemented by electronic hardware, computer software, or a combination of both. In the above description, each example's composition and steps have been described generally based on functions, so as to clearly illustrate the interchangeability of hardware and software. Whether these functions are executed by hardware or software depends on the specific application and design constraints of the technical solution. Professional technicians can use different methods to implement the functions described for each specific situation, but such implementation should not be considered beyond the scope of the present disclosure.

The present disclosure further provides a non-transitory computer-readable storage medium, which stores a computer program. The panoramic stitching method as described in the embodiments of the present disclosure is implemented when the computer program is executed by a processor. Those skilled in the art can understand that, all or part of the steps in the method for implementing the above embodiments can be implemented when the computer program is executed by a processor. The non-transitory computer-readable storage medium may be, for example, random access memory, read-only memory, flash memory, hard disk, solid-state disk, magnetic tape, floppy disk, optical disc and any combination thereof. The above storage medium can be any available medium that can be accessed by a computer, or a data storage device that integrates one or more available media, such as a server, a data center, etc. The available medium can be a magnetic medium (such as a floppy disk, a hard disk, or a magnetic tape), an optical medium (such as a digital video disc (DVD)), or a semiconductor medium (such as a solid state disk (SSD)), etc.

The present disclosure also provides a computer program. The computer program comprises one or more computer instructions. When these computer instructions are loaded and executed on a computing device, they generate all or part of the processes or functions described in the present disclosure. The computer instructions can be stored on a non-transitory computer-readable storage medium or transmitted from one medium to another, such as from a website, computer, or data center to another via wired (e.g., coaxial cable, optical fiber, digital subscriber line (DSL)) or wireless (e.g., infrared, wireless, microwave) means.

When executed by a computer, the computer program performs the above panoramic stitching method. The computer program can be a software installation package, which can be downloaded and executed on a computer when using the above panoramic stitching method.

The descriptions of the steps or structures corresponding to the drawings are respectively emphasized, and some steps or structures that are not detailed can be referred to the relevant descriptions of other steps or structures.

The above-mentioned embodiments are merely illustrative of the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. A panoramic stitching method, comprising:
acquiring captured images from cameras in a same scene;
obtaining a remapping lookup table and a fusion lookup table generated based on a stitching model, the stitching model comprising a hemisphere and a cylinder, and an origin of a virtual camera coordinate system associated with the cameras being located at a center of a bottom surface of the hemisphere in contact with the cylinder; and
successively mapping and fusing the captured images based on the remapping lookup table and the fusion lookup table to obtain a panoramic stitched output image.

2. The panoramic stitching method of claim 1, wherein a sphere center of the hemisphere is configured as the origin of the virtual camera coordinate system, and a radius of the hemisphere is configured as a farthest stitching distance,
wherein a center of an upper surface of the cylinder coincides with the origin of the virtual camera coordinate system, a center of a lower surface of the cylinder is configured as an origin of a world coordinate system, a radius of the cylinder corresponds to the farthest stitching distance, and a height of the cylinder is configured as an off-ground height of the cameras.

3. The panoramic stitching method of claim 1, wherein successively mapping and fusing the captured images based on the remapping lookup table and the fusion lookup table to obtain a panoramic stitched output image comprises:
performing texture mapping on overlapping regions of the captured images based on the remapping lookup table to obtain first mapped images;
performing texture mapping on non-overlapping regions of the captured images based on the remapping lookup table to obtain second mapped images;
performing image fusion on the first mapped images based on the fusion lookup table to obtain fused images; and
stitching the second mapped images and the fused images to obtain the panoramic stitched output image.

4. The panoramic stitching method of claim 1, further comprising: generating the remapping lookup table and the fusion lookup table, comprising:
calibrating the cameras to determine internal parameters and external parameters of the cameras;
configuring first stitching parameters and second stitching parameters, wherein the first stitching parameters are configured as imaging parameters of an output image, and the second stitching parameters are related to the stitching model;
constructing the remapping lookup table and the fusion lookup table based on the internal parameters, the external parameters, the first stitching parameters, and the second stitching parameters; and
saving the remapping lookup table and the fusion lookup table.

5. The panoramic stitching method of claim 4, wherein the first stitching parameters comprise at least one of a width of the output image, a height of the output image, a horizontal field of view of the output image, a vertical field of view of the output image, a horizontal offset of the center point of the output image, a vertical offset of the center point of the output image, and a projection mode of the output image,
wherein the second stitching parameters comprise an off-ground height of the cameras and a farthest stitching distance.

6. The panoramic stitching method of claim 4, wherein constructing the remapping lookup table based on the internal parameters, the external parameters, the first stitching parameters, and the second stitching parameters comprises:
traversing first coordinates (x, y) of the output image;
back-projecting each pair of the first coordinates (x, y) onto a spherical surface with the origin O_{c} of the virtual camera coordinate system as a sphere center, and denoting a corresponding projection point as P_{c} and a corresponding ray as
$${O}_{c} {P}_{c}^{dir} ;$$
calculating a direction vector
$${P}_{c}^{dir}$$
of the ray based on the first stitching parameters;
determining a mode length S of the direction vector
$${P}_{c}^{dir}$$
based on the second stitching parameters;
calculating second coordinates [P_{cx} P_{cy} P_{cz}]^{T} of the projection point P_{c} in the virtual camera coordinate system using a formula given by:
$${P}_{c} = S * {P}_{c}^{dir} ;$$
calculating third coordinates [X_{c} Y_{c} Z_{c}]^{T} of the projection point P_{c} in a different physical camera coordinate system based on the external parameters and the second coordinates [P_{cx} P_{cy} P_{cz}]^{T}; and
converting the third coordinates [X_{c} Y_{c} Z_{c}]^{T} into pixel coordinates (u, v) of corresponding input images based on the internal parameters.

7. The panoramic stitching method of claim 6, wherein calculating a direction vector
$${P}_{c}^{dir}$$
of the ray based on the first stitching parameters comprises using following formulas:
$$d x = \frac{2 * ( x - dst\_center \_x )}{dst\_width} * \frac{dst\_fov \_x}{360} ; \\ dy = \frac{2 * ( y - dst\_center \_y )}{dst\_height} * \frac{dst\_fov \_y}{180} ; and \\ {P}_{c}^{dir} = {( {P}_{cx}^{dir} , {P}_{cy}^{dir} , {P}_{cz}^{dir} )}^{T} = [ \begin{matrix}cos ( π * dy / 2. ) * sin ( π * dx ) \\ cos ( π * dy / 2. ) * cos ( π * dx ) \\ - sin ( π * dy / 2. )\end{matrix} ] ;$$
where dst_center_x represents a horizontal offset of a center point of the output image, dst_center_y represents a vertical offset of the center point of the output image, dst_fov_x represents a horizontal field of view of the output image, dst_fov_y represents a vertical field of view of the output image, dst_width represents a width of the output image, and dst_height represents a height of the output image.

8. The panoramic stitching method of claim 6, wherein determining a mode length S of the direction vector
$${P}_{c}^{dir}$$
based on the second stitching parameters comprises using following formulas:
when
$${P}_{cz}^{dir} > 0 , S = R ;$$
when
$${P}_{cz}^{dir} <= 0 and \frac{- {P}_{c z}^{dir}}{h} > R , S = \frac{R}{\sqrt{{( {P}_{c x}^{dir} )}^{2} + {( {P}_{c y}^{dir} )}^{2}}} ;$$
and
when
$${P}_{cz}^{dir} <= 0 and \frac{- {P}_{c z}^{dir}}{h} <= R , S = - \frac{h}{{P}_{c z}^{dir}} ;$$
where
$${P}_{c x}^{dir}$$
represents an x-direction coordinate point of the direction vector
$${P}_{c}^{dir} , {P}_{c y}^{dir}$$
represents a y-direction coordinate point of the direction vector
$${P}_{c}^{dir} , {P}_{cz}^{dir}$$
represents a z-direction coordinate point of the direction vector
$${P}_{c}^{dir} ,$$
R represents a farthest stitching distance, and h represents an off-ground height of virtual cameras.

9. The panoramic stitching method of claim 6, wherein calculating third coordinates [X_{c} Y_{c} Z_{c}]^{T} of the projection point P_{c} in a different physical camera coordinate system based on the external parameters and the second coordinates [P_{cx} P_{cy} P_{cz}]^{T} comprises using a formula given by:
$${P}_{0} = {T}_{0 c} * {P}_{c} ; {P}_{1} = {T}_{01}^{- 1} {T}_{0 c} * {P}_{c} ; and {P}_{2} = {T}_{02}^{- 1} {T}_{0 c} * {P}_{c}$$
where P_{c} represents the second coordinates [P_{cx} P_{cy} P_{cz}]^{T} of the projection point P_{c} in the virtual camera coordinate system, T_{0c} represents external parameter matrix, T₀₁ represents external parameters of Camera 1 relative to Camera 0, T₀₂ represents external parameters of Camera 2 relative to Camera 0, P₀ represents coordinates of the projection point P_{c} in coordinate system of Camera 0, P₁ represents coordinates of the projection point P_{c} in coordinate system of Camera 1, and P₂ represents coordinates of the projection point P_{c} in coordinate system of Camera 2.

10. The panoramic stitching method of claim 6, wherein converting the third coordinates [X_{c} Y_{c} Z_{c}]^{T} into pixel coordinates (u, v) of corresponding input images based on the internal parameters comprises using following formulas:
$$[ \begin{matrix}{x}^{′} \\ {y}^{′}\end{matrix} ] = [ \begin{matrix}{X}_{c} / {Z}_{c} \\ {Y}_{c} / {Z}_{c}\end{matrix} ] ; \\ {r}^{2} = {x}^{′2} + {y}^{′2} ; \\ [ \begin{matrix}{x}^{″} \\ {y}^{″}\end{matrix} ] = [ \begin{matrix}{x}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + 2 {p}_{1} {x}^{′} {y}^{′} + {p}_{2} ( {r}^{2} + 2 {x}^{′2} ) \\ {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′2} ) + 2 {p}_{2} {x}^{′} {y}^{′}\end{matrix} ] ; and \\ [ \begin{matrix}u \\ v\end{matrix} ] = [ \begin{matrix}{f}_{x} {x}^{″} + {c}_{x} \\ {f}_{y} {y}^{″} + {c}_{y}\end{matrix} ] ;$$
where k₁, k₂, k₃, k₄, k₅ and k₆ represent radial distortion coefficients, p₁ and p₂ represent tangential distortion coefficients, fₓ and f_{y} represent focal lengths of the cameras, and cₓ and c_{y} represent offsets of center points of the images.

11. The panoramic stitching method of claim 1, wherein successively mapping and fusing the captured images based on the remapping lookup table and the fusion lookup table to obtain a panoramic stitched output image comprises:
dividing the captured images into overlapping regions and non-overlapping regions;
performing texture mapping on the overlapping regions based on the remapping lookup table to obtain overlapping regions subjected to texture mapping;
performing image fusion on the overlapping regions subjected to texture mapping based on the fusion lookup table to obtain overlapping regions subjected to image fusion;
performing texture mapping on the non-overlapping regions based on the remapping lookup table to obtain non-overlapping regions subjected to texture mapping; and
stitching the overlapping regions subjected to image fusion and the non-overlapping regions subjected to texture mapping to obtain the panoramic stitched output image.

12. The panoramic stitching method of claim 11, wherein performing texture mapping on the overlapping regions based on the remapping lookup table comprises:
traversing coordinates (x, y) of the panoramic stitched output image;
querying, based on the coordinates (x, y), coordinates (mapx(x,y), mapy(x,y)) of corresponding input images in the remapping lookup table;
performing image content interpolation on the corresponding input images, and obtaining interpolation results at the coordinates (mapx(x,y), mapy(x,y)); and
filling the interpolation results into the coordinates (x, y) of the panoramic stitched output image.

13. The panoramic stitching method of claim 11, wherein performing image fusion on the overlapping regions subjected to texture mapping comprises:
performing image fusion on the overlapping regions subjected to texture mapping by one of an Alpha fusion algorithm, a multi-band fusion algorithm, and a Poisson fusion algorithm.

14. The panoramic stitching method of claim 13, wherein performing image fusion on the overlapping regions subjected to texture mapping by the Alpha fusion algorithm comprises:
traversing coordinates (x, y) of the panoramic stitched output image;
for each pair of the coordinates (x, y), querying a corresponding alpha value alpha(x, y) in the fusion lookup table;
acquiring a pixel value Image c(x,y) of corresponding input images;
calculating a fused pixel value based on the alpha value alpha(x, y) and the pixel value Image c(x, y); and
filling the fused pixel value into the coordinates (x, y) of the panoramic stitched output image.

15. The panoramic stitching method of claim 14, wherein calculating a fused pixel value based on the alpha value alpha(x, y) and the pixel value Image c(x,y) comprises using a formula given by:
$$Blend ( x , y ) = alpha ( x , y ) * Image 1 ( x , y ) + ( 1 - alpha ( x , y ) ) * Image 2 ( x , y ) ;$$
where alpha(x, y) represents the alpha value at the coordinates (x, y) in the fusion lookup table, Image1(x, y) represents the pixel value at the coordinates (x, y) in a first captured image, Image2(x,y) represents the pixel value at the coordinates (x, y) in a second captured image, and Blend(x,y) represents the fused pixel value.

16. The panoramic stitching method of claim 4, wherein calibrating the cameras to determine the internal parameters and the external parameters of the cameras comprises:
collecting images of a first calibration board for internal parameter calibration as first calibration images;
collecting images of a second calibration board for external parameter calibration as second calibration images;
processing the first calibration images and the second calibration images based on a preset calibration algorithm to obtain internal parameters, external parameters, and a re-projection error of the cameras; and
determining whether a calibration result of the cameras reaches a standard based on the re-projection error,
if yes, saving the internal parameters and the external parameters; and
if not, adjusting the first calibration board and the second calibration board, and/or replacing the preset calibration algorithm, and then calibrating the cameras until the calibration result of the cameras reaches the standard.

17. A panoramic stitching apparatus, comprising:
an image acquisition module, configured to acquire captured images from cameras in a same scene; and
an image stitching module, configured to:
obtain a remapping lookup table and a fusion lookup table generated based on a stitching model, the stitching model comprising a hemisphere and a cylinder, and an origin of a virtual camera coordinate system associated with the cameras being located at a center of a bottom surface of the hemisphere in contact with the cylinder; and
successively map and fuse the captured images based on the remapping lookup table and the fusion lookup table to obtain a panoramic stitched output image.

18. The panoramic stitching apparatus of claim 17, further comprising:
a lookup-table generation module, configured to generate the remapping lookup table and the fusion lookup table based on the stitching model.

19. The panoramic stitching apparatus of claim 17, wherein the image stitching module is configured to:
perform texture mapping on overlapping regions of the captured images based on the remapping lookup table to obtain first mapped images;
perform texture mapping on non-overlapping regions of the captured images based on the remapping lookup table to obtain second mapped images;
perform image fusion on the first mapped images based on the fusion lookup table to obtain fused images; and
stitch the second mapped images and the fused images to obtain the panoramic stitched output image.

20. An electronic device, comprising:
a memory, configured to store an executable program; and
the processor, configured to execute the program, so that the electronic device executes:
acquiring captured images from cameras in a same scene;
obtaining a remapping lookup table and a fusion lookup table generated based on a stitching model, the stitching model comprising a hemisphere and a cylinder, and an origin of a virtual camera coordinate system associated with the cameras being located at a center of a bottom surface of the hemisphere in contact with the cylinder; and
successively mapping and fusing the captured images based on the remapping lookup table and the fusion lookup table to obtain a panoramic stitched output image.
